(19) United States
(12) Patent Application Publication
(10) Pub. No.: US 2002/0010913 A1
(43) Pub. Date: Jan. 24, 2002

(54) Program profiling

(76) Inventor: Ulf Mikael Ronstrom, Hagersten (SE)

Correspondence Address: Richard J. Moura, Esq., Jenkens & Gilchrist, P.C., Suite 3200, 1445 Ross Avenue, Dallas, TX, 75202-2799, US

(21) Appl. No.: 09/745,701

(22) Filed: Dec. 22, 2000

(30) Foreign Application Priority Data
Dec. 30, 1999 (DE) DE 199 63 832.2

(51) Int. Cl. G06F 9/45

(52) U.S. Cl. 717/9

(57) ABSTRACT

To improve the overall execution efficiency for the execution of a program submitted to a virtual machine, there is proposed a program profiling method for a virtual machine starting with a compilation of a submitted program to generate a target program (S10). Then, the target program is executed to generate execution statistics (S12) being stored in a jump memory (28). Finally, the target program is recompiled (S22) using the execution statistics stored in the jump memory (28) as compiler support.

### FIELD OF INVENTION

The present invention relates to a method for profiling programs in virtual machines, a computer system using the same, and a computer program product being related thereto.

### BACKGROUND ART

Traditionally, programs have been written in a high-level programming language, and compilers translate the programs into a machine code that is executed on a particular processor to realize a certain user-specific application.

One such application is illustrated in FIG. 7 and is related to a telecommunication exchange. As shown in FIG. 7, on the hardware level the processor 100 is used in combination with the memory 102. With respect to the exchange functionality a suitable partition of the memory 102 may be selected for easy handling of messages and signals submitted for further processing, e.g., by using a plurality of buffers each having a pre-specified priority level and being again sub-divided into a plurality of registers. While FIG. 7 shows one such example for a hardware structure a large number of modifications and variations are well-known to the person skilled in the art and may as well be used to achieve the desired functionality.

As also shown in FIG. 7, on top of the hardware level the desired functionality is implemented using software programs. Typically, the functionality is coded using a high-level programming language 104. A compiler 106 transfers this high-level programming language description of the functionality into a machine code 108 that is finally executed on the processor 100.

FIG. 8 illustrates the functionality of the exchange shown in FIG. 7 on a higher abstraction level.

The functionality shown in FIG. 8 relates to the processing of messages—also referred to as signals in the following—submitted to the exchange for the further processing thereof. These messages are stored in the memory 102, in particular in buffers according to their priority level and then processed.

Therefore, FIG. 8 shows the initial checking of these buffers according to step S100. In case this step S100 indicates that messages are to be processed step S102 is carried out to schedule the processing of the submitted messages according to their respective priority levels. Hereafter, the actual processing of messages is carried out in step S104.

As shown in FIG. 8, steps S102 and S104 form an inner loop and are iteratively repeated until a predetermined number of messages is processed which condition is checked in step S106. The purpose of this inner loop is to avoid a too frequent check for received messages.

The further step S108 shown in FIG. 8 is related to the termination of the overall processing of messages and signals.

The exchange functionality according to FIGS. 7 and 8 is only to be understood as an example for the background art of the present invention. Nevertheless, this example emphasizes that a very efficient execution of the involved steps is crucial in view of real-time applications. Therefore, the question of how efficiently the high-level programming language is transferred into a machine code is of greatest importance.

To improve the efficiency of a machine code derived from a high-level program through compilation in EP 0 501 076 A2 there is described a system and method for comprehensive, non-invasive process filing of a processor to provide feedback to a program of the high-level program for the execution dynamics of the program. In particular, there is proposed a method of profiling code being executed in a computer system having a processor and a program counter for registering addresses for instructions executed by the processor generated by the code. The method comprises the sampling of the addresses from the program counter in correspondence to the instructions, the generation of a frequency count of the sampled addresses, and the derivation of count indications of time spent by the processor executing the instructions corresponding to the addresses. In other words, the approach described in EP 0 501 076 A2 relates to the profiling of processor execution time in computer systems.

Further, in EP 0 883 059 A2 there is described a compiler applicable to a non-blocking cache memory and a code scheduling method therefor. Here, the compiler comprises as front end an object code generation unit for generating a code of an object program and further a code scheduling unit for conducting code scheduling of an object code so as to reduce the cache miss penalty on the basis of the analysis result obtained from the front end and profile data. The code scheduling unit includes a profile data analysis unit for detecting cache miss penalty existing in profile data and a code scheduling execution unit for generating a dummy instruction code for lowering cache miss penalty and inserting the same into a machine code.

Therefore, in available compilers it has been necessary to first compile the program in a special mode to collect statistics about the program execution. Heretofore, the program compiled into a special mode writes profile information into special files which are then used by the compiler to improve the next version of the compiled program. Therefore, these approaches are not user-friendly at all and only very skilled persons may use this method for improving program performance.

Besides the optimisation approaches for compilers outlined above, another approach is that programs are not directly transferred into executable machine code but translated into a code for a virtual machine. One such example would be that a byte code generated on the basis of the Java programming language which is then executed by a Java virtual machine.

Virtual machines such as Java virtual machines simplify the use of profiling for the improvement of program performance and thus are more user-friendly. The virtual machine starts executing the virtual machine code or a quickly available derivative of this virtual machine code. The execution thereof leads to the generation of profiling information which may then be used through dynamically compiling an optimised version of the program. Here, the optimised version does not contain any machine code to gather profiling information.

One such example is the Hotspot Java virtual machine using a dynamic compilation technique in combination with an interpreter. At the beginning the complete program is executed by interpretation. An interpreter gathers execution statistics, e.g., which parts of a program are commonly executed and which paths of the program are normally executed in these parts. Then the dynamic compiler starts compiling the most common parts using the execution statistics generated by the interpreter. This allows to improve the efficiency of the generated compiled machine code.

However, the generation of the execution statistics may be dependent from the implementation of the interpreter itself, i.e. different interpreters may lead to different execution statistics which themselves need not necessarily be correlated in the same way to the execution statistics of the compiled machining code.

### SUMMARY OF INVENTION

In view of the above, the technical object of the present invention is to improve the overall execution efficiency for the execution of a program submitted to a virtual machine.

According to the present invention, this object is achieved through a method for program profiling in a virtual computation machine comprising the steps of compiling a submitted program to generate a target program, executingthe target program to generate execution statistics being stored in a jump memory, and recompiling said target program using the execution statistics stored in the jump memory as compiler support.

Therefore, according to the present invention, it is proposed to compile programs submitted to a virtual machine to generate a target program that may directly run on, e.g., a standard hardware platform. Then, the generated target program may be executed to generate execution statistics. According to the present invention, this execution statistics is stored in a jump memory. Then, the target program is recompiled using the execution statistics stored in the jump memory as compiler support.

Therefore, one idea underlying the present invention is to use the jump memory to provide profiling information as well as information useful for debugging and testing purposes. The costs of continuously writing to the jump memory are justified by the use of the information stored therein for the support of the subsequent compiling process and for debugging purposes.

Another important aspect of the present invention is that it is not necessary to execute the submitted program using a slower mechanism, e.g., an interpreter code to gather statistics about the target program execution. This has benefits both in real terms of efficiency of target program execution and also in terms of cash memory usage since only a single target program is used to execute the program.

Another important aspect of the invention is that it is only necessary to debug a single program in case errors occur. Contrary to the use of several execution mechanisms, the overall failure rate in a virtual machine is decreased since less code means less errors.

Still further, since at the beginning the virtual machine starts the compilation of the submitted program without any execution statistics it is possible to improve the overall start-up time of the virtual machine by using less optimisations in this first compilation step in comparison to later versions of the target program.

Overall, according to the present invention it is only necessary to use a single compilation process without the need to develop and maintain an interpreter. Also, there does not exist the need to create a special version of the compiled target program to generate execution statistics. Still further, the jump memory may not only be used for compiler support but also for subsequent fault recovery. Also, an increase in efficiency is achieved since the execution of the submitted program is based on compiled program immediately after the start of the virtual machine without any intermediate interpretation thereof.

Therefore, the new solution combines the use of a jump memory to deduce information about the program execution, the gathering of execution statistics and passing of this information to a compiler. The application of this concept in a virtual machine leads to a new solution where the jump memory is used to derive statistics about the target program execution. Therefore, it is not necessary to use any special mode of the compiled program to collect execution statistics, thus improving the reliability of the system and increasing the execution efficiency when gathering execution statistics and improving cash memory usage.

According to a preferred embodiment, the recompilation step is carried out a plurality of times to achieve an iterative improvement of the target program.

Therefore, this preferred embodiment allows to provide a new version of the target program every time the target program needs optimisation.

According to yet another preferred embodiment of the present invention, it is checked whether a recompilation should be carried out each time an analysis interval for the analysis of the generated execution statistics has elapsed. Here, this analysis interval may be specified either as maximum number of steps of the target program to be executed or as time interval.

This preferred embodiment tackles the problem to gather the information from the jump memory and to re-send it to the compiler in a most efficient way. In other words, this preferred embodiment considers the fact that the compiler does not need all jumps ever taken in the virtual machine to improve the generated target program and that it is enough to collect the data in the jump memory at a certain time interval. Therefore, at every analysis interval, e.g., 1 msec the jump memory is read out and the contents thereof is sent to the compiler which then carries out the analysis and deduces when it is necessary to recompile a submitted program or a program module.

According to yet another preferred embodiment of the present invention the write step into the jump memory is only carried out in case a previously established jump rate for a conditional or unconditional jump is below a certain pre-specified threshold.

Therefore, this preferred embodiment of the present invention allows to consider the fact that after a certain number of optimisation steps usually the most frequently used paths in a program are established and do not change so that in case a high jump rate for a certain program step has already been established before no further information of use for the compilation process will be generated anyhow. Therefore, the writing of such an information into the jump memory will only require unnecessary processing time without leading to an improved subsequent compilation process.

According to a further aspect of the present invention, there is provided a computer system adapted to carry out a virtual machine processing of submitted machine code, comprising an I/O interface means, a memory, a processor, wherein the memory stores compiler software adapted to enable an iterative optimisation of a submitted program through the following steps: compiling the submitted program to generate a target program; execution of the target program to generate execution statistics being stored in a jump memory; and recompiling the target program using the execution statistics stored in the jump memory as compiler support.

This computer system allows to achieve the same advantages as outlined above with respect to the method according to the method according to the present invention.

Preferably, the computer system further comprises virtual machine program code adapted to execute part of the submitted program through interpretation instead of compilation.

Therefore, besides the optimised compilation in the sense of the present invention it is also possible to split the execution of the submitted program on the basis of the compilation and interpretation to increase overall flexibility.

According to yet another preferred embodiment of the present invention, there is provided a computer program product directly loadable into the memory of the computer system comprising software code portions for performing the steps of the inventive method when the product is run on a processor of the computer system.

Therefore, the present invention also allows to provide computer program products for use within a computer program or a processor comprised in, e.g., a hardware platform supporting a virtual machine.

The programs defining the functions of the present invention may be supplied to a computer/processor in many forms, including, but not limited to information permanently stored on non-writable storage media, e.g., read-only memory devices such as ROM or CD ROM disc, readable by processors or computer I/O attachments; information stored on writable storage media, i.e. floppy discs and hard drives; or information conveyed to a computer/processor through communication media such as network and/or telephone networks via modems or other interface devices. It should be understood that each medium—when carrying processor-readable instructions implementing the inventive concept—represents embodiments of the present invention.

### DESCRIPTION OF DRAWINGS

In the following, preferred embodiments of the present invention will be described with reference to the drawings in which

FIG. 1 shows a schematic diagram of a virtual machine according to the present invention;

FIG. 2 shows a flowchart of the compiler optimisation processor according to the present invention;

FIG. 3 shows a flowchart for the collection of execution statistics according to the present invention;

FIG. 4 shows a flowchart for a modified approach to collect execution statistics according to the present invention;

FIG. 5 shows an example for the application of the compilation optimisation process according to the present invention;

FIG. 6 shows a flowchart for the application of the virtual machine shown in FIG. 1 in a telecommunication exchange;

FIG. 7 shows a telecommunication exchange as typical application example for hardware and software systems according to the prior art; and

FIG. 8 shows a flowchart for the operation of the telecommunication exchange shown in FIG. 7.

### DESCRIPTION OF PREFERRED EMBODIMENTS

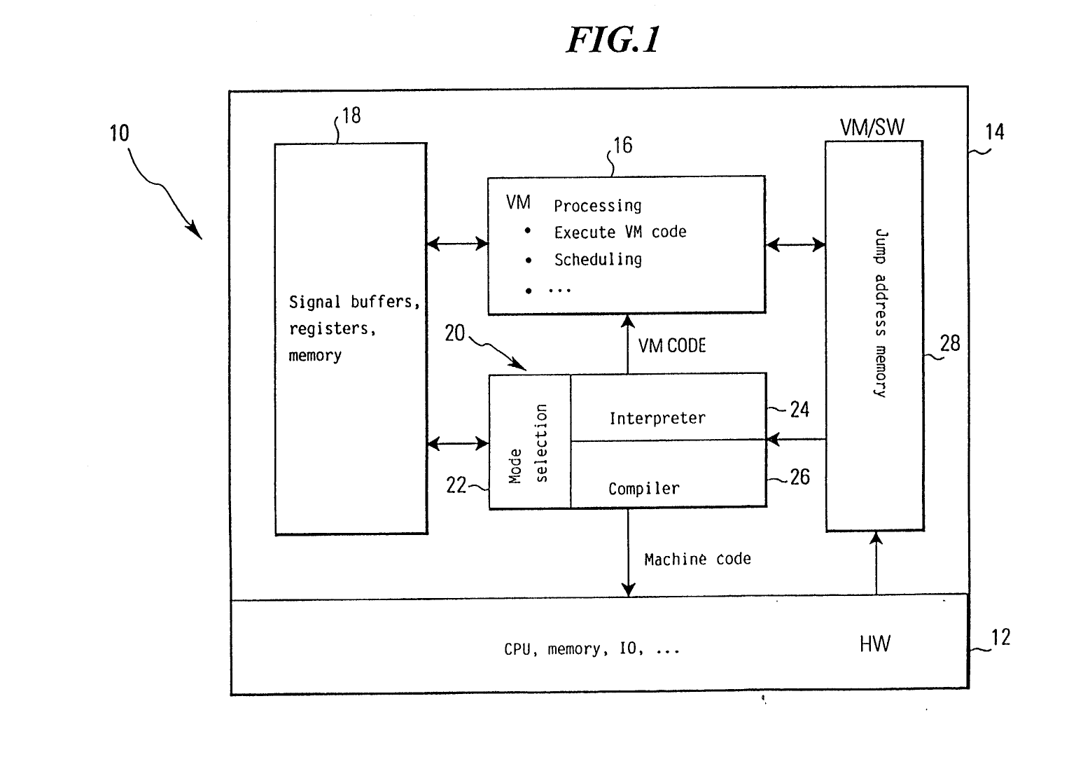

FIG. 1 shows a schematic diagram of a virtual machine according to the present invention. The virtual machine as discussed in the following, however, is only to be understood as an illustrated example by the virtual machine concept. Therefore, the optimised compiling process according to the present invention may be applied to any kind of virtual machine as long as such a virtual machine does not only rely on interpretation of program codes submitted to the virtual machine but also on compilation of such a submitted program code.

As shown in FIG. 1, the virtual machine is implemented on top of a hardware platform comprising a processor, memory and input/output interface as well as peripherals. Within the framework of the present invention, the particular form of processing unit, memory, input/output devices, etc., is to be considered as non-limitating so that no detailed explanation thereof will be given. To the contrary, any kind of hardware that is able to support virtual machine concepts is to be considered as lying well within the scope and gist of the present invention as outlined below.

As also shown in FIG. 1, the virtual machine 10 comprises a part 14 being implemented in software. This software-related part takes over functions being specific for the virtual machine. One such example will be referred to as virtual processing 16 in the following, which virtual processing is related to the execution of so-called virtual machine code. This virtual machine code may be derived from a program submitted to the virtual machine, e.g., through translation of the submitted program. This allows to achieve the execution of externally supplied program code which typically is tuned for a specific hardware platform on the hardware platform of the virtual machine. In other words, the virtual machine 10 allows to use previously developed programs or program modules also on new hardware platforms 12 without a revision of already existing programs.

As also shown in FIG. 1, the virtual machine comprises a memory part 18, e.g., being implemented as data structure in the virtual machine software and being adapted for the intermediate storage of externally supplied programs or program modules as well as further information which is necessary for the execution of the virtual machine software.

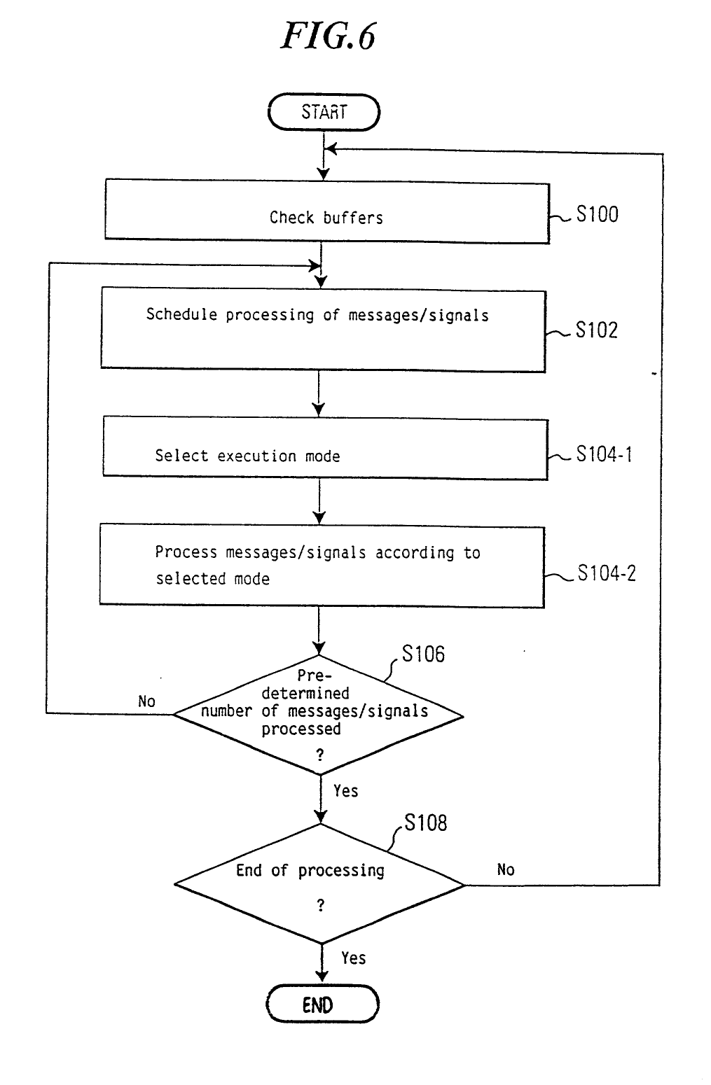

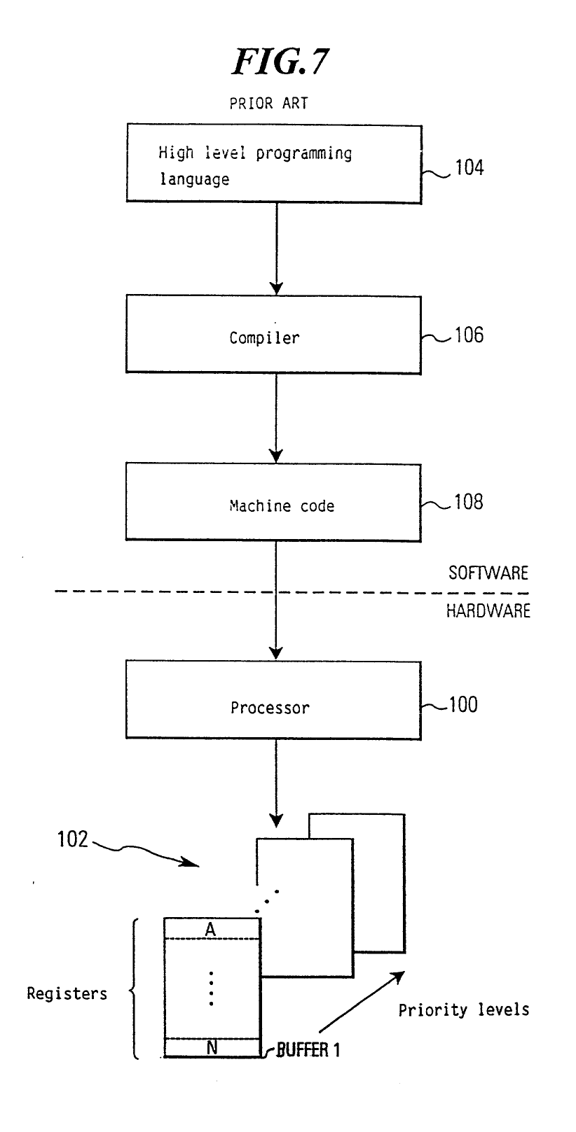

In case the virtual machine 10 is supplied to a telecommunication exchange as will be discussed in more detail below with respect to FIG. 6 such intermediate data may be related to messages or to signals supplied to the telecommunication exchange and be related to the signal buffers and registers outlined above with respect to FIG. 7. However, this is only to be understood as one application example of the present invention and not to be construed as limiting the scope of protection thereof.

As shown in FIG. 1, the virtual machine program also comprises an input program handling part 20 that prepares the execution of the program stored in the memory part 18 forthe further execution on the virtual machine 10. Here, this input program handling part 20 comprises a mode selector 22, an interpreter 24, and a compiler 26. The mode selector decides whether an inputted program is executed through interpretation or compilation and therefore selectively supplies the input program to either the interpreter 24 or the compiler 26. While in FIG. 1 the compiler 26 is shown as being related to the virtual machine it may be recognized that the compiler may also run on a separate machine.

As also shown in FIG. 1, both the virtual processing unit 16 and the input program handling part 20 have access to a jump memory 28 to either execute a writing thereto or read from this jump memory. One option to implement the jump memory may be a cyclic buffer, e.g., of 8 Kbyte in size. Further, for the operation of the jump memory there will be provided a pointer pointing to the last submitted entry in the jump memory. After each submission of an entry to the jump memory the pointer will be implemented. In case the implemented pointer points to the last memory cell of the jump memory, the pointer will not be implemented but set back to the first memory cell of the jump memory thus achieving the cyclic jump memory. Alternatively, it is also possible to store a single bit for jump in the jump memory, e.g., storing a bit 1 in case a branch is taken and storing a bit 0 in case a branch is not taken.

As already outlined above, operatively an input program may be submitted to the virtual machine 10 via the memory part 18. Then the input program handling part 20 reads the input program and determines in the mode selector 22 whether this input program is to be interpreted or executed as compiled code. In case of interpretation by the interpreter 24 a virtual memory code is generated which constitutes input data for the virtual module processing unit 16. Otherwise, the compiler 26 generates machine code to be directly executed on the hardware platform 12.

The jump memory 28 shown in FIG. 1 according to the present invention is provided to support an optimisation of the input program execution. Further, the jump memory 28 also referred to as jump address memory 28 may also be used for debugging and fault recovery purposes during the input program execution.

In particular, during execution of the input program by interpretation the virtual memory code is supplied to the virtual module processing unit 16. In case of jumps, the related jump start address and/or jump stop address will be written into the jump address memory 28. Here, it should be noted that each jump start address and/or jump stop address may be either of the real address type or the logical address type. Therefore, this allows to achieve an execution statistics for the executed virtual memory code for subsequent improved interpretation.

Further, in case of compilation during the execution of the machine code also execution statistics are gathered by writing jump start addresses and/or jump stop addresses into the jump address memory 28.

As shown in FIG. 1, the execution statistics stored in the jump address memory 28 may either be used by the virtual module processing unit 16 or by the compiler for optimisation of the execution of the submitted input program. Also, the generated information may be used for fault recovery purposes.

As already outlined above, an idea of the present invention is to use the jump address memory to provide execution statistics as profiling information as well as information useful for debugging and testing purposes. Therefore, the costs of writing into the jump address memory are justified through the achievement of an optimised input program execution.

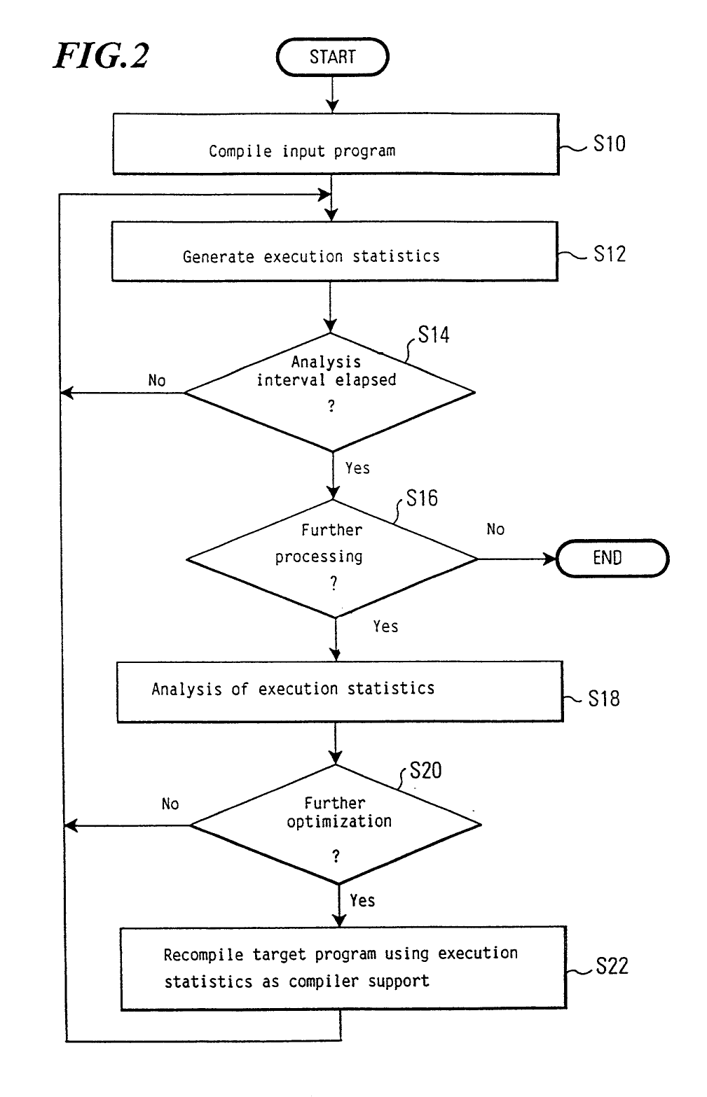

In the following, in more detail description of the compiling of the input program will be given with respect to the flowchart shown in FIG. 2. As will be explained in more detail in the following, the present invention differs over the prior art in that the compilation process is not triggered through previous interpretation of the input program as for the dynamic compilation but is based on executable programs running on the hardware platform 12. Therefore, the optimisation is triggered by programs running on the hardware platform 12 of the virtual machine 10 and not by results of an interpretation process as for the dynamic compilation process described above.

Therefore, according to the present invention it is proposed to first compile the input program in a step S10. This compilation process may lead to a machine code running on a standard processor, microcomputer, proprietary hardware, etc., or whatever is appropriate. Therefore, the submitted input program is mapped into a target program. This allows to use previously developed program or program modules also on new platforms and therefore to achieve protection of investment costs into software.

As also shown in FIG. 2, the generated target program is then executed on the hardware platform 12 during a step S12 to generate execution statistics. As already explained above, the execution statistics are written into the jump memory 28.

Further, it is to be preferred that the generation of execution statistics is carried out for certain time interval or number of steps in the target program and only then to interrupt this generation of execution statistics for further optimisation of the already existing target program.

In a further step S16 it is determined whether the overall execution of the input program should be terminated or not. If this is not the case there follows a step S18 to carry out an analysis of the generated execution statistics. This analysis S18 of the execution statistics forms the basis for the determination of step S20, i.e. whether a further optimisation is necessary or not. If it is determined in step S20 that a further optimisation is necessary step S22 will be carried out to recompile the currently existing target program while using the execution statistics as compiler support.

As shown in FIG. 2, the recompilation step S22 is carried out a plurality of times to achieve an iterative improvement of the target program. Also, a recompilation step S22 is carried out each time an analysis interval for the analysis of the generated execution statistics has elapsed.

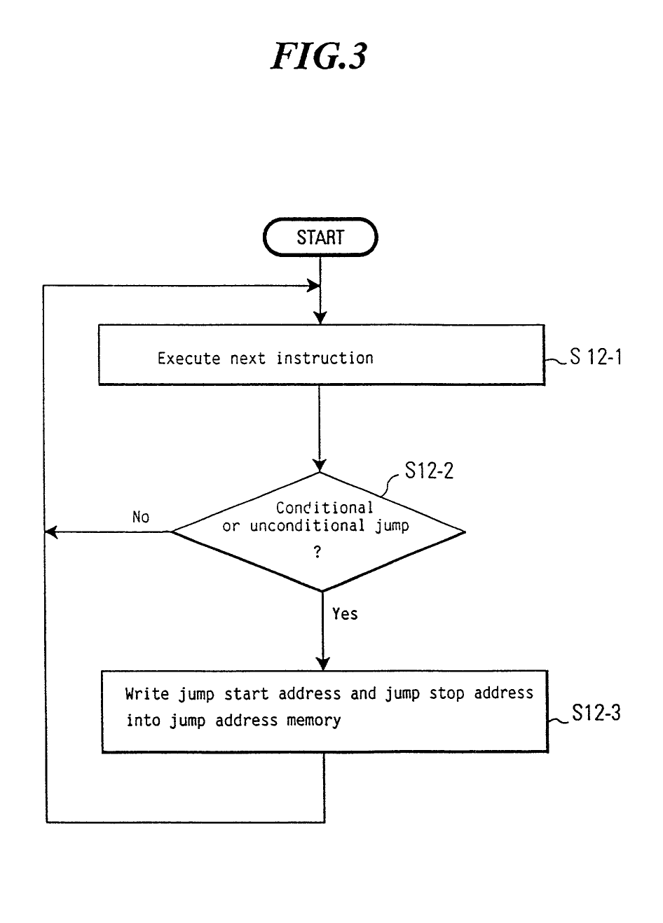

FIG. 3 shows a flowchart for the generation of the execution statistics according to step S12 shown in FIG. 2.

As shown in FIG. 3, in a step S12-1 the next instruction of the target program, e.g., the next step of the machine code is executed. In a step S12-2 it is then determined whether the executed instruction of the target program is a conditional or an unconditional jump of the target program. If this interrogation is affirmative, step S12-3 is executed to write the jump start address and/or the jump stop address into the jump address memory. Otherwise, the next instruction of the target program is immediately executed according to step S12-1 as shown in FIG. 3.

Therefore, the storage of jump start addresses and/or jump stop addresses allows to generate information on the most frequently used parts of the target program and further the program flow therein, i.e. the most relevant path of target program execution. In case this information is supplied to the compiler, it may be used to carry out a specific optimisation of the most relevant parts of the target program. Therefore, contrary to the prior art the optimisation of the compiling process is not triggered through previous interpretation of the parts of the input programs to be optimised but through actually compiling the input parts and then gathering execution statistics using a generated target program, e.g., machine code running on a commercially available CPU or processor.

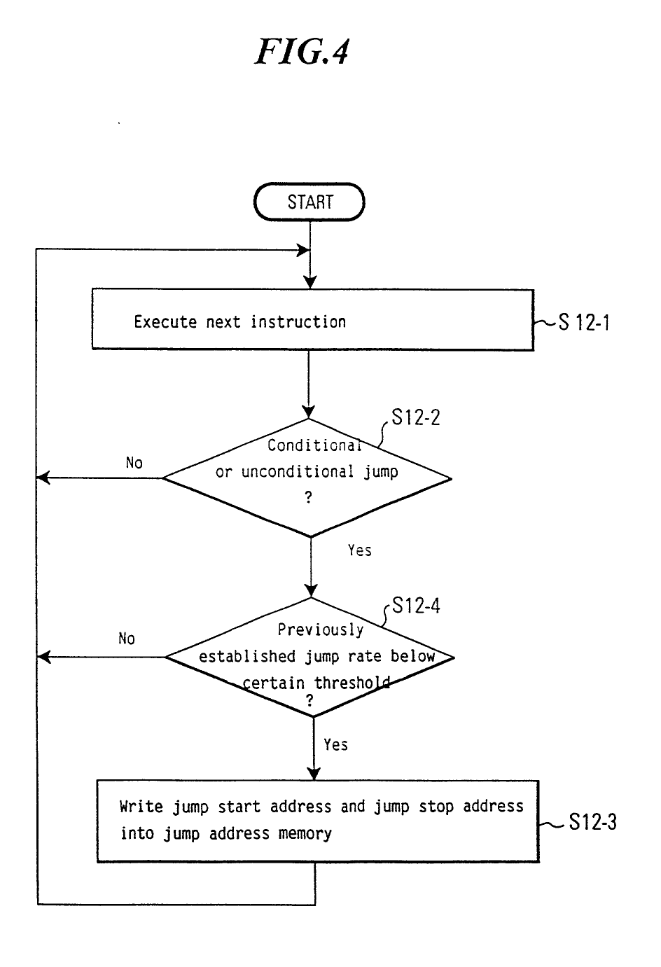

FIG. 4 shows a modification for the generation of the execution statistics as shown in FIG. 3.

In particular, the jump start address and/or the jump stop address is only written into the jump address memory in case a previously established jump rate for this conditional or unconditional jump is below a certain pre-specified threshold according to step S12-14. This modification considers the iterative nature of the optimisation process illustrated in FIG. 2. In other words, after a certain number of iteration it will be clear that certain parts of a target program are of more importance than other ones. Therefore, in case jump addresses with respect to those parts are written to the jump memory 28 no real new information is generated but only a confirmation of already existing knowledge on optimisation criteria is repeated. Therefore, the collection of such information may be skipped to avoid unnecessary writings into the jump address memory and therefore the unnecessary loss of computation time. Typical values for such a threshold lie in the range from 50 to 90%. Therefore, only those jumps which are not carried out too often will be considered for the subsequent optimisation thus achieving a reduced effort for the access to the jump address memory.

It should be noted that according to the present invention the compilation of the input program into the target program may either lead to directly executable code that runs on the hardware platform 12 or to machine code that uses library functions. In the latter case, the virtual machine processing unit 16 loads in library functions to enable the execution of the target program.

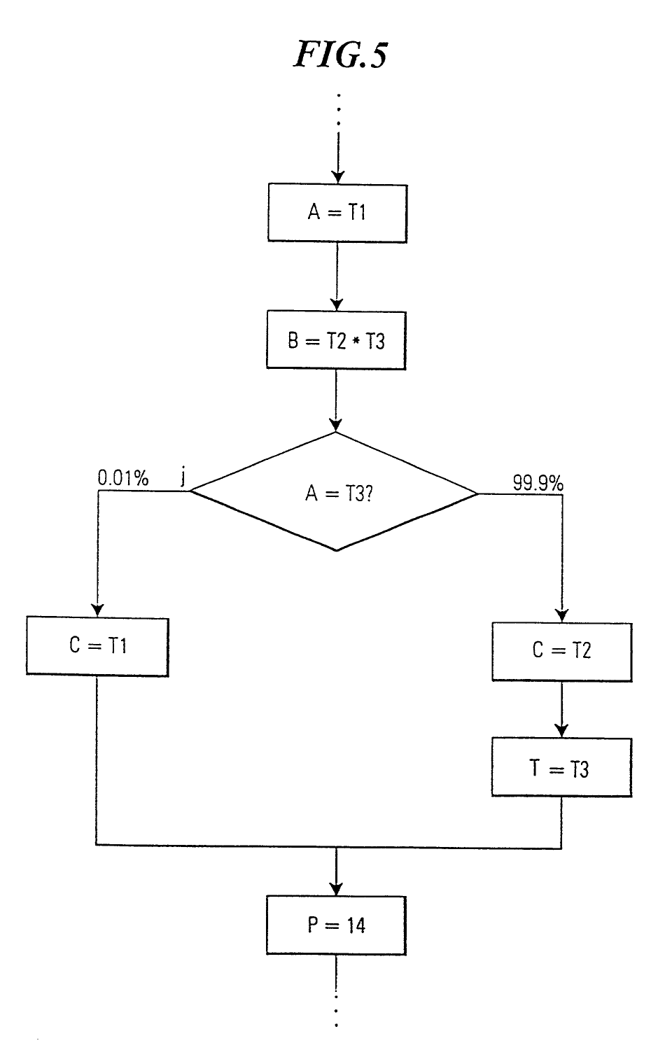

In the following, an example for the compiler optimisation process for a virtual machine according to the present invention will be given with respect to the calculation flowchart shown in FIG. 5.

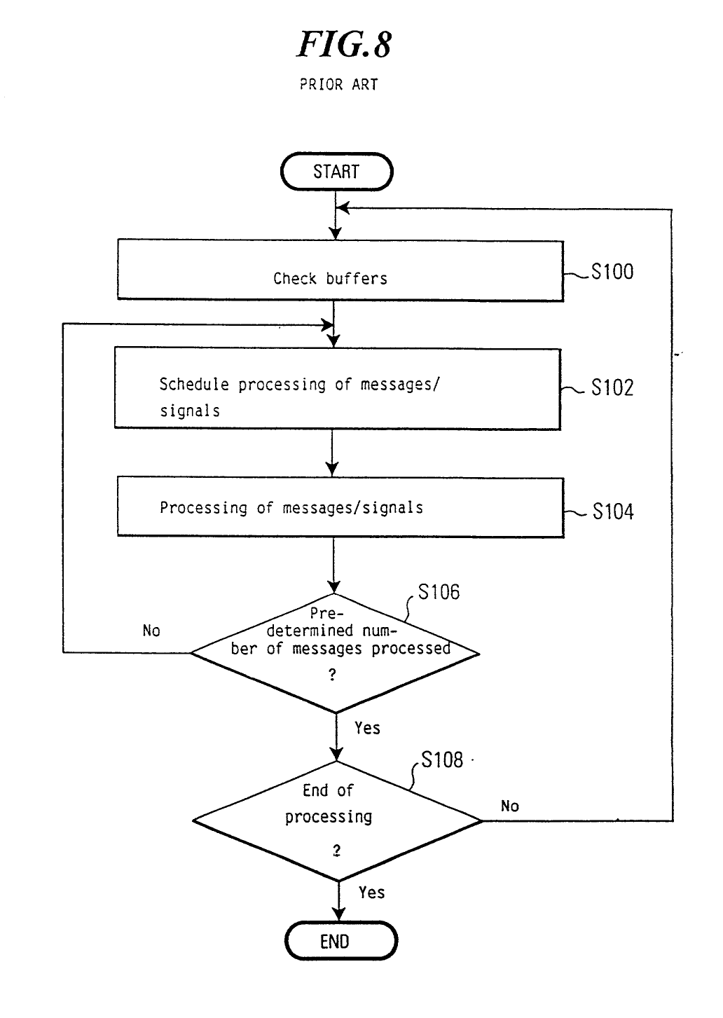

This example shows that while above the compiler optimisation process has been described with reference to a virtual machine, it may also be applied to the general compilation of source programs into machine codes as explained above with reference to FIGS. 7 and 8.

FIG. 5 shows a flowchart for a part of an input program in the form of a source code having a high-level program language description, e.g., as follows:

:

A=T1;

B=T2*T3;

IF (A=T3) THEN

C=T1;

ELSE

C=T2;

T=T3;

ENDIF

P=14;

:

Here, it is assumed that this description may be adapted to any particular programming language, e.g., the Pascal language, the APL language, the C language, the C++ language, or whatever other kind of appropriate language which might be suitable.

Further, for the subsequent explanation of the compiler optimisation process no particular reference to any specific machine code or assembler code is made but only to a general style description of the compilation result to avoid any restriction of the scope of the present invention.

In case the compiler optimisation process is applied to the virtual machine concept it is assumed that the high level programming language is transferred into, e.g., a first machine code adapted to a first hardware. However, there may arise the case where this generated machine code equivalently referred to as input machine code must be executed on a different hardware platform, e.g., when up-grading existing systems. Therefore, the input machine code must be transferred into a target machine code for subsequent execution on the different hardware platform.

Therefore, compilation in the sense of the present invention either means mapping of a high-level programming language description into an executable machine code or compilation from an input program into a target program, e.g., from an input machine code into a target machine code according to the virtual machine computing concept.

For the purpose of explanation it is assumed that the high-level programming language description given above for the calculation process shown in FIG. 5 leads to an input machine code as follows:

| | | |
|---|---|---|
| . | | |
| . | | |
| . | | |
| 1000 | LOAD | R_A, R_T1; |
| 1001 | LOAD | R_M, R_T2; |
| 1002 | MULPL | R_M, R_T3; |
| 1003 | LOAD | R_B, R_M; |
| 1004 | LOAD | R_CMP, R_A; |
| 1005 | JUMPC | R_CMP, R_T3, 3; |
| 1006 | LOAD | R_C, R_T1; |
| 1007 | JUMPU | 1010; |
| 1008 | LOAD | R_C, R_T2; |
| 1009 | LOAD | R_T, R_T3; |
| 1010 | LOAD | R_P, 14; |
| . | | |
| . | | |
| . | | |

Therefore, for the purposes of explanation it is assumed that to each variable of the high-level programming language there is assigned a register. Therefore, the first step A=T1 of the calculation corresponds to step 1000 of the input machine code, i.e. to the writing of the contents of the register R_T1 into the register R_A; further the computation step B=T2*T3 corresponds to the input machine code steps 1001 to 1003 where initially the contents of the register R_T2 is written into the multiplying register R_N (1001) which is then multiplied with the contents of the register R_T3 (1002) which result is then written into the register R_B (1003). What follows is the loading of the compare register R_CMP with the value of the variable A (1004); in case the contents of the compare register R_CMP is not equal to the contents of the register R_T3, a conditional jump by three steps is executed (1005). Otherwise, the calculation step C=T1 is executed (1006). Then an unconditional jump to the calculation step P=14 (1010) is carried out (1007). Otherwise, the second branch of the IF/ELSE/ENDIF statement will be carried out (1008/1009).

As outlined above, there may be exist the requirement to map this input machine code into a different code which will be referred to as target program or equivalently target machine code in the following and for the purpose of explanation is assumed to be defined as follows:

| | | |
|---|---|---|
| . | | |
| . | | |
| . | | |
| 1000 | LD | R_A, R_T1; |
| 1001 | MUL | R_B, R_T2, R_T3; |
| 1002 | LD | R_CMP, R_A; |
| 1003 | JC | R_CMP, R_T3, 3; |
| 1004 | LD | R_C, R_T1; |
| 1005 | JU | 1008; |
| 1006 | LD | R_C, R_T2; |
| 1007 | LD | R_T, R_T3; |
| 1008 | LD | R_P, 14; |
| . | | |
| . | | |
| . | | |

Therefore, the target machine code achieves the same functionality as the input machine code but may be adapted, e.g., to a different processor and thus use a different assembler representation of the high-level programming language description of the process illustrated in FIG. 5.

One typical example is the simplified representation of the multiplication in the input machine code (1001 to 1003) according to a summarized instruction in the target machine code (1001). This modified syntax may also lead to different jump addresses, e.g., for the unconditional jump after carrying out the first branch of the IF/ELSE/ENDIF statement (1005) in the target machine code.

In the following the application of the inventive compile optimisation process will be described. Here, it should be noted that this optimisation process may already be applied to the transfer of the high-level description into the input machine code or equivalently during the compilation of the input machine code into the target machine code.

For the purpose of explanation in the following the application of compiler optimisation process according to the present invention will be explained with respect to the target machine code. For the generation of execution statistics it is necessary to insert steps carrying out a writing of jump start addresses and/or jump stop addresses into the jump memory 28. Heretofore, an instruction carrying out a writing into the jump address WJAM is inserted to the target machine code as shown in the following:

| | | |
|---|---|---|
| . | | |
| . | | |
| . | | |
| 1000 | LD | R_A, R_T1; |
| 1001 | MUL | R_B, R_T2, R_T3; |
| 1002 | LD | R_CMP, R_A; |
| 1003 | JC | R_CMP, R_T3, 3; |
| 1004 | LD | R_C, R_T1; |
| 1005 | JU | 1009; |
| 1006 | WJAM | JC, 1003, 1006; |
| 1007 | LD | R_C, R_T2; |
| 1008 | LD | R_T, R_T3; |
| 1009 | WJAM | JU, 1005, 1009; |
| 1010 | LD | R_P, 14; |
| . | | |
| . | | |
| . | | |

The explanation of this modified code is the same as given above with the only difference being the insertion of the WJAM instruction. This statement at least writes a jump start address and a jump stop address into the jump address memory after the execution of a jump and optionally also the type of jump, i.e. conditional (JC) or unconditional (JU). This information may then be used to derive the probability of the execution of certain program paths, as shown in FIG. 5.

One such example would be that mainly the right branch of the flowchart is executed (99.9%) while the left path remains mainly unused (0.01%). In this case the compiler may put compiler code for the execution of the right branch already before the execution of the IF/ELSE/ENDIF statement as shown in the following optimised target machine code:

| | | |
|---|---|---|
| . | | |
| . | | |
| . | | |
| 1000 | WR | R_A, R_T1; |
| 1001 | MUL | R_B, R_T2, R_T3; |
| 1002 | WR | R_C, R_T2; |
| 1003 | WR | R_T, R_T3; |
| 1004 | WR | R_CMP, R_A; |
| 1005 | JC | R_CMP, R_T3, 2; |
| 1006 | WR | R_C, R_T1; |
| 1007 | WJAM | JC, 1005, 1007; |
| 1008 | WR | R_P, 14; |
| . | | |
| . | | |
| . | | |

Giving the sure knowledge of the execution paths the memory access for gathering the related variables may be parallelized with the activities before the execution of the IF/ELSE/ENDIF statement.

Another improvement is that the number of jumps is reduced and therefore also the probability of a cache miss.

However, it should be understood that this is only an example to illustrate the execution and that all other compiler optimisation steps commonly known to the person skilled in the art may as well be used during the compiler optimisation process. Since all these techniques are well-known to the person skilled in the art no further explanation thereof will be given here.

Further, it should also be noted that while above the compiler optimisation technique according to the present invention has been explained—i.e., generation of execution statistics using a jump memory—this compiler optimisation technique may also be combined with an interpretation of the input machine code on top of a virtual machine as shown in FIG. 1.

One such example would be a telecommunication exchange being built on top of a virtual machine where a combined interpretation/compilation approach may be used to increase flexibility.

To achieve the same functionality as outlined above with respect to FIGS. 7 and 8, the process illustrated in FIG. 8 must be modified as shown in FIG. 6. Those parts of the execution being identical to the steps previously explained with respect to FIG. 8 are denoted using the same reference numerals and a repeated explanation thereof will be omitted in the following.

As shown in FIG. 6, the process running in the telecommunication exchange and running on a virtual machine splits the processing of messages/signals according to step S104 shown in FIG. 8 into two steps S104-1 and S104-2. Therefore, initially an execution mode, i.e. interpretation or compilation is determined for each submitted input program module in step S104-1. Then, in step S104-2 the messages/signals stored in the memory part 18 of the virtual machine 10 are processed according to the selected mode. Therefore, there is not only achieved a more hardware-independent realization of the telecommunication exchange but also a scalability between ease of implementation and optimisation for run time and efficiency.

Further, from the description given above with respect to the present invention, it is clear that the present invention also relates to a computer program product which may be variably loaded into the internal memory of the hardware platform to perform the steps of the inventive compiler optimisation process when the product is run on the processor of the hardware platform. Still further, the invention relates as well to a processor program product stored on a processor-usable medium and provided for compiler optimisation comprising processor-readable program means to carry out any of the steps of the inventive compiler optimisation. Typically, such media are, e.g., floppy discs, hard discs, CDs, ROM, RAM, EPROM, EEPROM chips, cape, cartridge with integrated circuit, ZIP drive, or storage based on downloading from the internet.

The foregoing description of preferred embodiments has been presented for the purpose of illustration and description. It is not intended to be exhaustive or to limit the invention to the precise form disclosed. Obvious modifications or variations are possible in the light of the above technical teachings. The embodiments have been chosen and described to provide the best illustration of the principles underlying the present invention as well as its practical application and further to enable one of ordinary skill in the art to utilize the present invention in various embodiments and with various modifications as are suited to the particular use contemplated. All such modifications and variations are within the scope of the invention as determined by the appended claims.

1. A program profiling method for a virtual machine, comprising the steps of:
compiling a submitted program to generate a target program;
executing said target program to generate execution statistics being stored in a jump memory; and
recompiling said target program using the execution statistics stored in said jump memory as compiler support.

2. The method of claim 1, wherein
said recompilation step is carried out a plurality of times to achieve iterative improvement of said target program.

3. The method of claim 1, wherein
said recompilation step is carried out each time an analysis interval for an analysis of said generated execution statistics has elapsed.

4. A program profiling method for a virtual machine, comprising the steps of:
compiling a submitted program to generate a target program;
executing said target program to generate execution statistics being stored in a jump memory; and
recompiling said target program using said execution statistics stored in said jump memory as compiler support, wherein
said generation of said execution statistics comprises the following sub-steps:
execution of a next instruction to be executed in said target program;
evaluation of said next instruction to determine whether it leads to a conditional or unconditional jump; and
writing said jump start address and/or said jump stop address into said jump memory in case of a jump.

5. The method of claim 4, wherein
said step to write said jump start address and/or said jump stop address into said jump memory is only carried out in case a previously established jump rate for said conditional or unconditional jump is below a certain pre-specified threshold.

6. The method of claim 5, wherein
said pre-specified threshold is lying in a range from 50% to 90%.

7. A computer system adapted to carry out a virtual machine processing of submitted machine code, comprising:
an I/O interface unit,
a memory,
a processor, wherein
said memory stores compiler software adapted to enable an iterative optimisation of a submitted program through
compiling the submitted program to generate a target program;
executing said target program to generate execution statistics being stored in a jump memory; and
recompiling said target program using said execution statistics stored in said jump memory as compiler support.

8. The computer system of claim 7, wherein
said jump memory is adapted to store jump start addresses and/or jump stop addresses.

9. The computer system of claim 7, wherein
said memory further stores a virtual machine interpretation program adapted to execute said submitted program through interpretation.

10. The computer system of claim 7, wherein
a determination of the execution mode for submitted program is executed in a mode selection module.

11. A computer program product directed loadable into the memory of a computer system, comprising software code portions for performing the steps of:
compiling a submitted program to generate a target program;
executing said target program to generate execution statistics being stored in a jump memory; and
recompiling said target program using said execution statistics stored in said jump memory as compiler support.

12. A processor program product stored on a processor-usable medium and provided for virtual machine compiler optimisation, comprising:
a processor-readable program for compiling submitted program to generate a target program;
a processor-readable program for executing said target program to generate execution statistics; and
a processor-readable program for recompiling the target program using said execution statistics as compiler support.
